(19) United States
(12) Patent Application Publication
(10) Pub. No.: US 2026/0043438 A1
(43) Pub. Date: Feb. 12, 2026

(54) BALL RETURN END CAP AND LINEAR MOTOR THEREOF

(71) Applicant: SHENZHEN CRONUS TECHNOLOGY CO., LTD., Shenzhen (CN)

(72) Inventor: Guang YANG, Shenzhen (CN)

(21) Appl. No.: 19/359,807

(22) Filed: Oct. 16, 2025

Related U.S. Application Data
(63) Continuation of application No. PCT/CN2024/079697, filed on Mar. 1, 2024.

(51) Int. Cl. F16C 33/38; F16C 29/06; F16C 33/66; H02K 41/02

(52) U.S. Cl. CPC F16C 33/38; F16C 29/0697; F16C 33/66; H02K 41/02; F16C 2380/26

(57) ABSTRACT

The present invention relates to a ball return end cap and a linear motor thereof, including an end cap body having a ball-returning channel, the ball-returning channel has a first return port and a second return port, the end cap body is provided with an oil passage connecting to the outside that communicates with the ball-returning channel. The end cap body has a ball-returning channel through which the ball can enter/exit from the first return port and exit/enter from the second return port. In addition, the oil passage is disposed on the end cap body and communicates with the ball-returning channel, so that lubricating oil can directly lubricate the interior of the ball circulating slide rail on the rotor, providing good lubrication for the balls; lubricating oil can also provide good lubrication for the ball-returning channel, ensuring smoother returning of the ball return end cap.

### TECHNICAL FIELD

The present invention relates to the technical field of stroke driving devices, particularly to a ball return end cap and a linear motor thereof.

### BACKGROUND

Linear motor is a transmission device that directly converts electrical energy into linear motion mechanical energy without the need for any intermediate conversion mechanism, and can be seen as a rotating motor that is cut radially and flattened into a plane. Linear motor, also known as linear type electric motor, linear type motor, linear electric motor, and push rod motor, and the most commonly used types of linear motor include flat plate type, U-shaped groove type, and tube type.

Ball return end cap is a structure used in ball linear motors to rotate the ball, and the use of ball return end cap enables the ball rotate and circulate in the ball circulation slide rail in the rotor.

During the operation of a linear motor, the track on the stator slide or the ball circulating slide rail on the rotor should be lubricated in a timely manner to maintain smooth motion of the rotor. A separate lubrication mechanism is often required to lubricate conventional linear motors, but it is is difficult for an additional lubrication mechanism to lubricate the interior of the ball circulating slide, resulting in poor lubrication performance.

### SUMMARY

In order to solve the problem that the lubrication mechanism's difficulty to lubricate into the interior of the ball circulating slide rail results in poor lubrication effect, the present invention proposes a ball return end cap and a linear motor thereof.

In the technical solution adopted by the present invention, a ball return end cap comprises an end cap body having a ball-returning channel, the ball-returning channel has a first return port and a second return port, the end cap body is provided with an oil passage connecting to the outside that communicates with the ball-returning channel.

Preferably, the oil passage extends to the position of the first return port.

Preferably, the oil passage is a notch opened on the surface of the end cap body and extending to the first return port, and the notch is configured to seal with the external structure to form the oil passage.

Preferably, the first return port protrudes outward from the end cap body to form an installation portion.

Preferably, the installation portion is provided with a gap, and the oil passage communicates with the gap.

Preferably, at least two ball-returning channels are provided, and multiple ball-returning channels communicate with the oil passage.

Preferably, the ball-returning channel is provided with a groove structure that is inwardly recessed away from the ball-returning channel, and the groove structure is disposed along the direction of ball return path of the ball-returning channel.

Preferably, the end cap body comprises an end cover plate and a ball return plate, and the end cover plate and the ball return plate together form the ball-returning channel.

Preferably, one of the end cover plate and the ball return plate is, at their joint position, provided with a groove structure that is inwardly recessed away from the ball-returning channel, and the groove structure is disposed along the direction of ball return path of the ball-returning channel.

Preferably, the end cap body has a first oil inlet, the end cap body is connected to an oil box, and the oil box, the first oil inlet, and the oil passage are sequentially connected.

The present invention proposes a linear motor comprising a stator slide rail and a rotor that slidably fits on the stator slide rail, comprising a ball return end cover mentioned above, and the ball return end cover is connected to the rotor.

Compared with the prior art, the present invention has the following beneficial effects:

The present invention discloses a ball return end cap, comprising an end cap body having a ball-returning channel, the ball-returning channel has a first return port and a second return port, the end cap body is provided with an oil passage connecting to the outside that communicates with the ball-returning channel. The end cap body has a ball-returning channel through which the ball can enter/exit from the first return port and exit/enter from the second return port. In addition, the oil passage is disposed on the end cap body and communicates with the ball-returning channel, so that lubricating oil can directly lubricate the interior of the ball circulating slide rail on the rotor, providing good lubrication for the balls; lubricating oil can also provide good lubrication for the ball-returning channel, ensuring smoother returning of the ball return end cap.

The present application also discloses a linear motor, comprising a stator slide rail and a rotor that slidably fits on the stator slide rail, including the above-mentioned ball return end cover, and the ball return end cover is connected to the rotor. Based on the installation of the ball return end cap disclosed in the present application, the linear motor can achieve better lubrication effect and ball return effect, higher accuracy, smaller volume, and more compact structure.

Compared with prior art, the ball return end cap and a linear motor thereof disclosed by the present invention can lubricate the interior of the ball circulating slide rail and improve the lubrication effect.

### BRIEF DESCRIPTION OF THE DRAWINGS

The present invention will be described in detail with reference to the embodiments and accompanying drawings:

FIG. 1 shows a structural diagram of a ball return end cap provided according to an embodiment of the present invention;

FIG. 2 shows a structural diagram of a ball return end cap provided in FIG. 1 in another direction;

FIG. 3 shows a structural diagram of a ball return plate in a ball return end cap provided according to FIG. 1;

FIG. 4 shows a structural diagram of a ball return plate of the ball return end cover provided in FIG. 3 in the other direction;

FIG. 5 shows a structural diagram of the middle end cover plate of a ball return end cover provided according to FIG. 1;

FIG. 6 shows a structural diagram of the stator in a linear motor provided according to an embodiment of the present invention.

### DESCRIPTION OF REFERENCE NUMERALS

10. End cap body; 11. End cover plate; 12. ball return plate; 13. Groove structure; 14. Second limiting portion;
20. ball-returning channel; 21. First return port; 22. Second return port;
30. Oil passage; 31. First oil inlet; 32. Second oil inlet; 33. Connecting port;
40. Installation portion; 41. Gap; 42. First limiting portion;
50. Rotor; 51. Installation fit portion.

### DETAILED DESCRIPTION OF THE EMBODIMENTS

To clarify the purpose, technical solution, and advantages of the present invention more clearly, the embodiments of the present invention will be further described in detail below in conjunction with the accompanying drawings. Examples of the embodiment are shown in the accompanying drawings, where identical or similar reference numerals, from beginning to end, represent identical or similar components, or the components with identical or similar functions. The embodiments described below with reference to the accompanying drawings are exemplary and are only used to explain the present invention, and cannot be construed as limiting the present invention.

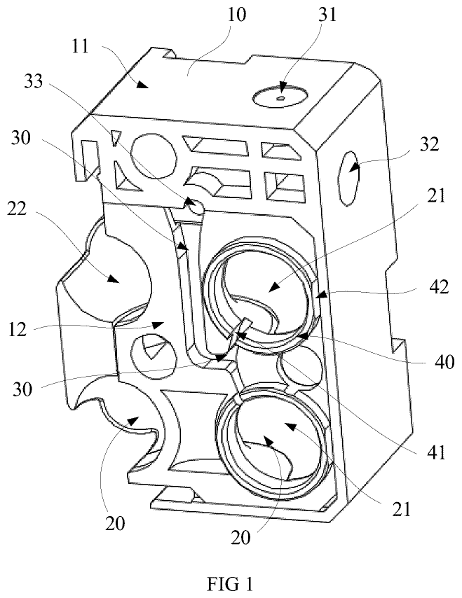

The present invention discloses a ball return end cap, as shown in FIG. 1 to FIG. 6, comprising an end cap body 10 having a ball-returning channel 20, the ball-returning channel 20 has a first return port 21 and a second return port 22, the end cap body 10 is provided with an oil passage 30 connecting to the outside that communicates with the ball-returning channel 20.

The end cap body 10 has a ball-returning channel 20 through which the ball can enter/exit from the first return port 21 and exit/enter from the second return port 22. In addition, the oil passage 30 is disposed on the end cap body 10 and communicates with the ball-returning channel 20, so that lubricating oil can directly lubricate the interior of the ball circulating slide rail on the rotor 50, providing good lubrication for the balls; lubricating oil can also provide good lubrication for the ball-returning channel 20, ensuring smoother returning of the ball return end cap.

It should be noted that the ball return cover, relative to other structural components on the rotor 50, is the component that comes into closest contact with the ball, with a larger contact area with the ball, and meanwhile, the balls in the ball return cover generate more abundant rotational motion than them in other positions, therefore the oil passage 30 disposed on the ball return cover can better achieve lubrication for the ball. In addition, it is precisely because of the closest contact between the ball return cover and the ball that the ball is extremely prone to jamming at the ball return cover, therefore the oil passage 30 that is disposed on the ball return cover and connecting to the ball-returning channel 20 can also provide good lubrication for the ball-returning channel 20, making the ball return cover smoother during ball return.

It should also be noted that since the oil passage 30 is located on the end cap body 10 to avoid the additional arrangement of the oil passage 30 on other external lubrication structures, so that the end cap body 10 not only rotate rotating balls conventionally, but also has lubrication function. On the other hand, as the present application avoids the need for additional lubrication structures, the use of the ball return end cap disclosed in the present application can reduce size and make the overall structure more compact.

Specifically, this embodiment does not limit the specific position of the oil passage 30 in the ball-returning channel 20, and the oil passage 30 can be connected to the middle of the ball-returning channel 20, or to any side of the middle of the ball-returning channel 20 and, of course, the oil passage 30 can also be connected to the first return port 21 or the second return port 22, thereby lubricating the ball and the ball-returning channel 20. Due to the lubricating oil carried on the ball, other positions where the ball reaches are also lubricated.

The present application does not limit the shape of the end cap body 10, and the shape of the end cap body 10 in the accompanying drawings is only one embodiment of the present application. In other embodiments, the shape of the end cap body 10 can be centrally symmetrical, so that both sides of the end cap body 10 can be connected to other structures such as the rotor 50. In addition, in other embodiments, the first return port 21 and the second return port 22 have the same shape and size, and their positions are symmetrical with respect to the center of the end cap body 10, so that the operator can decide to make the first return port 21 or the second return port 22 be closer to the stator slide rail, or the upper and lower positions of the first return port 21 and the second return port 22. It should also be noted that at least one ball-returning channel 20 is provided, and the number of first return ports 21 and second return ports 22 matches that of ball-returning channels 20.

In further, the oil passage 30 can be located inside the end cap body 10 and can be, in the form of notch, sealed with an external structure to form the oil passage 30. The oil passage 30 can also be disposed inside the end cap body 10 on one section, and disposed in a notchted form on the other section. In some embodiments, when the oil passage 30 is converted from a channel provided inside the end cap body 10 to a notchted form, the oil passage 30 is connected through the connecting port 33, and lubricating oil flows through the internal channel, connecting port 33, and the notch to the ball-returning channel 20 in sequence.

Specifically, the connection between oil passage 30 and the outside can be an external pipeline at the location of the external connection, through which lubricating oil enters oil passage 30; an oil box can also be provided at an externally connected location to store lubricating oil that can flow into oil passage 30 for lubrication. In other embodiments, an oil storage material, which is used to store lubricating oil, may be provided inside the oil passage 30, and during the movement of the rotor 50, the lubricating oil on the oil storage material can be applied on the ball for lubrication, and after the lubricating oil on the oil storage material is used up, lubricating oil needs to be replenished at the position connected to the outside. Obviously, lubricating oil can also enter the oil passage 30 from the outside through other structures.

In some embodiments, as shown in FIG. 1 to FIG. 5, the oil passage 30 extends to the position of the first return port 21.

Specifically, at the position where the oil passage 30 extends to the first return port 21, for the two return ports in this embodiment, the return port connected to the oil passage 30 is the first return port 21, and the other is the second return port 22. The oil passage 30 is disposed at the first return port 21 so that the ball is more likely to be lubricated in the ball-returning channel 20, and is better lubricated as long as the ball enters the ball-returning channel 20. It should be noted that the rotor 50 can move back and forth on the stator slide rail, so the ball always has a chance to enter from the first return port 21 and leave from the second return port 22.

The position of the first directional port can be a notch opened at the first return port 21, a through-hole on the side wall of the first return port 21 connected to the oil passage 30, or a lubrication ring opened in the circumferential direction of the first return port 21, so that the oil passage 30 and the first return port 21 are mutually communicated. It should be explained that the position of the first return port 21 or the position of the second return port 22 refers to a part of the area near the ball inlet and outlet, not merely the position of the ball inlet and outlet.

In some embodiments, as shown in FIG. 1 to FIG. 5, the first return port 21 and the second return port 22 are disposed horizontally, the first return port 21 is away from the stator slide rail, and the second return port 22 is close to the stator slide rail, so that the ball, after being lubricated by lubricating oil, can immediately slide in contact with the stator slide rail and, on the one hand, more lubricating oil is carried to the stator slide rail, and on the other hand, the ball can be fully lubricated in the ball-returning channel 20, therefore the ball return end cover provides better lubrication effect on the linear motor, enabling a smoother returning of the ball return end cover and improving the operating accuracy of linear motor.

In other embodiments, the first return port 21 and the second return port 22 are disposed horizontally, the first return port 21 is close to the stator slide rail and the second return port 22 is away from the stator slide rail, so that the ball, after lubrication at the first return port 21, immediately comes into contact with the stator slide rail, ensuring more lubricating oil at the stator slide rail, and the stator slide rail is uniformly lubricated in this embodiment.

Uniform lubrication is applied to each ball without uneven lubrication, therefore a more uniform lubrication effect is provided for the stator slide rail when the balls come into contact with the stator slide rail.

In some specific embodiments, as shown in FIG. 1 to FIG. 5, the oil passage 30 is a notch opened on the surface of the end cap body 10 and extending to the first return port 21, and the notch is configured to seal with the external structure to form the oil passage 30.

Specifically, oil passage 30 is a notch on the surface of the end cap, extending to the first return port 21, and the notch can be combined with external structures to seal and form oil passage 30. The design of notchting, on the one hand, can reduce the difficulty of providing oil passage 30 on the end cap body 10, and minimize the processing steps, especially for the case where branches of oil passage 30 are required, the processing difficulty is more complex for branch oil passages; on the other hand, the notchting design can make it more convenient for operators to clean oil stains. For some infrequently used ball return end cover of linear motors, the long-term accumulation of lubricating oil in the oil passage 30 may cause blockage of the oil passage 30, while the notchting design can effectively facilitate cleaning operations for operators.

In addition, due to the open structure of the notch, the operator who intends to control the flow of lubricating oil can easily add a flow control structure inside the notch, such as an external gasket, to control the oil output by changing the cross-sectional area of the oil passage 30.

The notch is disposed on the surface of the end cap body 10, so that the end cap body 10 has higher structural strength, making it less prone to deformation and damage.

In some specific embodiments, as shown in FIG. 1 to FIG. 3, the first return port 21 protrudes outward from the end cap body 10 to form an installation portion 40.

Specifically, the first return port 21 protrudes outward from the end cap body 10 to form an installation portion 40, the installation portion 40 facilitates the installation of rotor 50, improves the simplicity of assembly process, and also play a certain limiting role. In addition, the installation portion 40 can improve the sealing performance of ball return end cap and rotor 50, preventing the leakage of lubricating oil.

Preferably, a first limiting portion 42 is also provided at the installation portion 40 to prevent the rotation of installation portion 40 when the installation portion 40 is installed on the rotor 50, thereby improving the installation accuracy of ball return end cap.

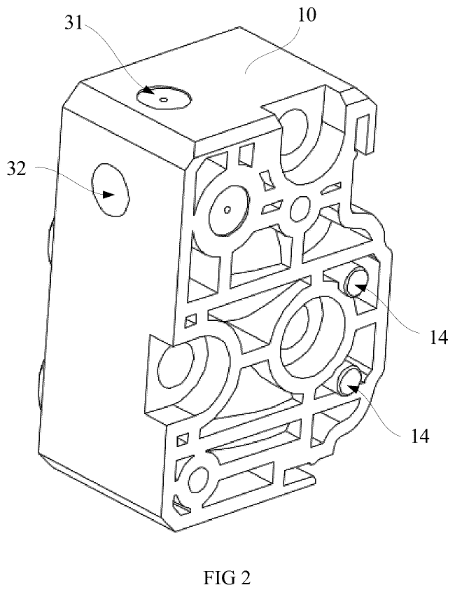

In some embodiments, as shown in FIG. 2, the end cap body 10 is provided with a second limiting portion 14 to ensure a more tight fit between the ball return end cap and other structures. Preferably, the second limiting portion 14 has two protrusions that can be integrated with the ball return end cap.

Preferably, an installation fit portion 51 can be provided on the rotor 50, and the installation portion 40 and the installation fit portion 51 fit with each other to provide better sealing effect, and connect and fix the ball return end cover better.

In other embodiments, an installation portion 40 protruding outward from the end cap body 10 may also be provided at the second return port 22.

In some embodiments, the end cap body 10 has a through hole, and the operator can fix the end cap body 10 and rotor 50 using bolts.

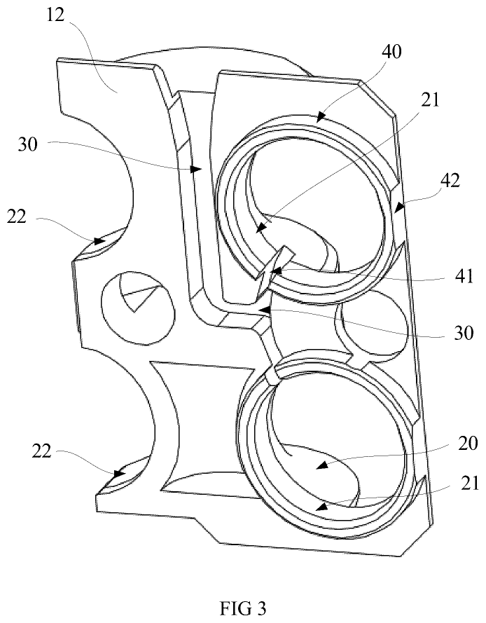

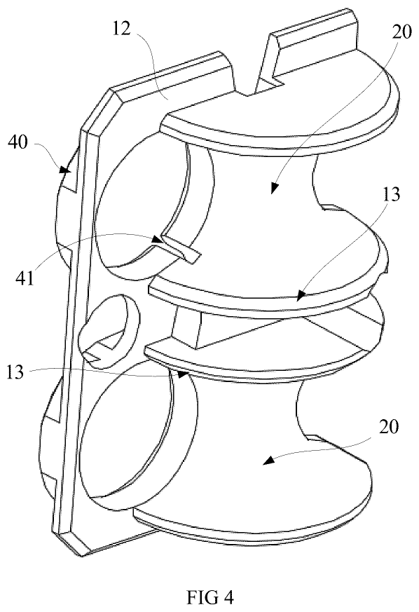

In some more specific embodiments, as shown in FIG. 1, FIG. 3, and FIG. 4, the installation portion 40 is provided with a gap 41, and the oil passage 30 communicates with the gap 41.

In further, the installation portion 40 has a gap 41, and the oil passage 30 communicates with the gap 41, the opening located at the installation portion 40 can avoid the arrangement of hole at other positions of the first return port 21 and, it should be noted that during the process of circulating the ball, the rotating ball, during returning process, will cause a certain degree of impact force on the ball return end cover, especially at the position where the ball direction changes, that is, at the rotation position of the ball-returning channel 20. Therefore, the hole connected to the oil passage 30 at the gap 41 of installation portion 40 can avoid damage caused by the impact force of the ball, and the service life of the ball return end cap can be extended because of its higher structural strength.

In some embodiments, as shown in FIG. 1 to FIG. 5, at least two ball-returning channels 20 are provided, and multiple ball-returning channels 20 communicate with the oil passage 30.

Specifically, compared to a single ball-returning channel 20, at least two ball-returning channels 20 can provide rotor 50 with higher stability during operation, but it should be noted that the number of ball-returning channels 20 is limited by manufacturing costs and the size of rotor 50, so the number of ball-returning channels 20 should be selected according to specific needs.

Multiple ball-returning channels 20 communicate with oil passage 30, so that each ball-returning channel 20 is lubricated by lubricating oil.

Preferably, as shown in FIG. 1 and FIG. 3, oil passage 30 includes a main oil passage and at least two branch oil passages, one end of the main oil passage communicates with the outside, and the other end communicates with multiple branch oil passages, allowing lubricating oil to be added from one point in the main oil passage. In other embodiments, the branch oil passage can also be connected to another branch oil passage for flow control.

In other embodiments, multiple oil passages 30 may be provided to communicate with multiple ball-returning channels 20, or may communicate with different positions in a ball-returning channel 20.

In some embodiments, as shown in FIG. 1, FIG. 3 and FIG. 4, the ball-returning channel 20 is provided with a groove structure 13 that is inwardly recessed away from the ball-returning channel 20, and the groove structure 13 is disposed along the direction of ball return path of the ball-returning channel 20.

It should be noted that, the ball-returning channel 20 is provided with a groove structure 13 that is inwardly recessed away from the ball-returning channel 20, and the groove structure 13 is disposed along the direction of ball return path of the ball-returning channel 20, the groove structure 13 can provide certain guidance for the balls and, to a certain extent, alleviate some of the pressure concentrated on the wall of the ball-returning channel 20, so that the ball return end cover provides better ball returning effect. Preferably, the groove structure 13 is located at the bottom and/or top of the ball-returning channel 20 and, due to the self gravity of the ball, placing groove structure 13 at the bottom and/or top of the ball-returning channel 20 can improve its ball returning effect.

It should be explained that the size of groove structure 13 relative to the ball-returning channel 20 cannot be too large, otherwise better ball return effect cannot be achieved when most part of the ball is trapped in the groove structure 13.

Preferably, as shown in FIG. 1, FIG. 3, and FIG. 4, the groove structure 13 is a chamfered structure which, compared to the groove structure 13, has a smoother contact surface with the ball and higher structural strength, making it less prone to damage. Specifically, the angle range for opening chamfer structures is between 10° and 80° (the normal angle range for chamfers is between 0° and 90°).

In some embodiments, as shown in FIG. 1 to FIG. 5, the end cap body 10 comprises an end cover plate 11 and a ball return plate 12, and the end cover plate 11 and the ball return plate 12 together form the ball-returning channel 20.

During the movement of rotor 50, the impact force of the ball is mainly concentrated at the rear end of end cover body 10, so the end cover plate 11 is more prone to damage compared to the ball return plate 12, and therefore the vulnerable parts can be replaced conveniently by separating the end cover body 10 into end cover plate 11 and ball return plate 12.

In some specific embodiments, as shown in FIG. 1 to FIG. 5, one of the end cover plate and ball return plate is, at their joint position, provided with a groove structure 13 that is inwardly recessed away from the ball-returning channel 20, and the groove structure 13 is disposed along the direction of ball return path of the ball-returning channel 20.

Specifically, if the end cap body 10 is integrally formed, opening groove structure 13 will face higher difficulty, while the independent arrangement of the end cap plate 11 and ball return plate 12 can make it easier to process and open the groove structure 13. In addition, to make groove structure 13 more easily, groove structure 13 is disposed at the joint position of one of the end cover plate 11 and ball return plate 12, that is, the edge position of end cover plate 11 or ball return plate 12.

Preferably, compared to the groove structure 13, the groove structure 13, a chamfered structure, has a smoother contact surface with the ball and higher structural strength, making it less prone to damage. Specifically, the angle range for opening chamfer structures is between 10° and 80° (the normal angle range for chamfers is between 0° and 90°).

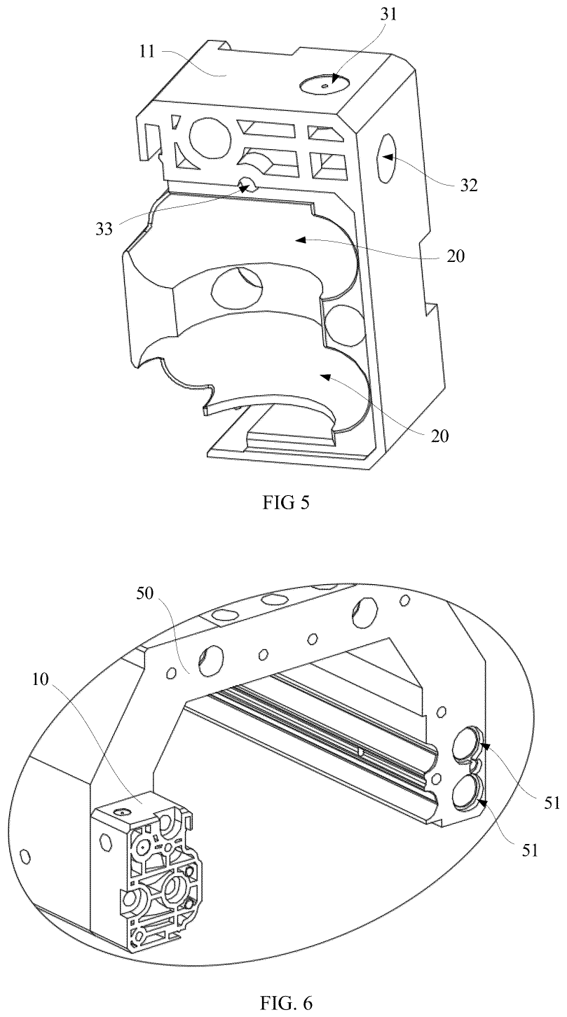

In some embodiments, as shown in FIG. 1, FIG. 2, FIG. 5 and FIG. 6, the end cap body 10 has a first oil inlet 31, the end cap body 10 is connected to an oil box, and the oil box, first oil inlet 31, and oil passage 30 are sequentially connected.

It should be noted that the end cap body 10 has a first oil inlet 31 that can be integrated with an external oil box to achieve lubrication function without the need for external components, reducing the size of rotor 50 and making the overall structure more compact.

Preferably, as shown in FIG. 1, FIG. 2, FIG. 5 and FIG. 6, the end cap body 10 also has a second oil inlet 32 that can be connected to external pipelines for adding lubricating oil, the end cap body 10 has a first oil inlet 31 and a second oil inlet 32, which can be selected according to the user's specific usage needs, thereby improving the adaptability of ball return end cap.

The present invention also discloses a linear motor, as shown in FIG. 6, comprising a stator slide rail and a rotor 50 that slidably fits on the stator slide rail, comprises a ball return end cover connected to the rotor 50.

Based on the installation of the ball return end cap disclosed in the present application, the linear motor can achieve better lubrication effect and ball return effect, higher accuracy, smaller volume, and more compact structure.

In the description of the present specification, the reference to the terms “one embodiment”, “some embodiments”, “illustrative embodiments”, “examples”, “specific examples”, or “some examples” means that the specific features, structures, materials, or characteristics described in conjunction with the embodiments or examples are included in at least one embodiment or example of the present application. In the specification, the illustrative expressions of the above terms may not necessarily refer to the same implementation or examples. Moreover, the specific features, structures, materials, or characteristics described can be combined in any one or more embodiments or examples in an appropriate manner.

In the description of the present specification, it should be noted that unless otherwise specified and limited, the terms “installation”, “provided with”, “sleeved/connected with”, “connection”, etc. should be broadly understood and, for example, “connection” can be a fixed connection, a detachable connection, or an integral connection; and can be a mechanical connection or an electrical connection; can be direct connection, indirect connection through an intermediate medium, or internal connection between two assemblies. The person having ordinary skill in the art can understand the specific meanings of the above terms in the present application in specific situations.

In the description of the present invention, relational terms such as “first” and “second”, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

The above description of the embodiments intends to help the person having ordinary skill in the art to understand and apply the technology of this case, and person skilled in the art can easily make various modifications to these embodiments and apply the general principles explained here to other embodiments without creative labor. Therefore, this case is not limited to the above embodiments, and modifications to the following should fall within the scope of protection of this case: \textcircled{1} new technical solutions based on the technical solution of the present invention and combined with existing common knowledge, which generate technical effects that do not exceed the technical effects of the present invention; \textcircled{2} equivalent substitution of some features of the technical solution of the present invention using well-known technology, which produces the same technical effect as the technical effect of the present invention; \textcircled{3} expansion based on the technical solution of the present invention, and the substantive content of the expanded technical solution does not exceed the scope of the technical solution of the present invention; \textcircled{4} equivalent transformations made using the content of the present invention specification and drawings, which are directly or indirectly applied to other related technical fields.

What is claimed is:

1. A ball return end cap, comprising an end cap body, and the end cap body has a ball-returning channel, the ball-returning channel has a first return port and a second return port, the end cap body is provided with an oil passage connecting to outside that communicates with the ball-returning channel.

2. The ball return end cap of claim 1, wherein the oil passage extends to the position of the first return port.

3. The ball return end cap of claim 2, wherein the oil passage is a notch opened on the surface of the end cap body and extending to the first return port, and the notch is configured to seal with an external structure to form the oil passage.

4. The ball return end cap of claim 2, wherein the first return port protrudes outward from the end cap body to form an installation portion.

5. The ball return end cap according to claim 4, wherein the installation portion is provided with a gap, and the oil passage communicates with the gap.

6. The ball return end cap of claim 1, wherein at least two ball-returning channels are provided, and multiple ball-returning channels communicate with the oil passage.

7. The ball return end cap of claim 1, wherein the ball-returning channel is provided with a groove structure that is inwardly recessed away from the ball-returning channel, and the groove structure is disposed along the direction of ball return path of the ball-returning channel.

8. The ball return end cap of claim 1, wherein the end cap body comprises an end cover plate and a ball return plate, and the end cover plate and the ball return plate together form the ball-returning channel.

9. The ball return end cover of claim 8, wherein one of the end cover plate and the ball return plate is, at their joint position, provided with a groove structure that is inwardly recessed away from the ball-returning channel, and the groove structure is disposed along the direction of ball return path of the ball-returning channel.

10. The ball return end cap of claim 1, wherein the end cap body has a first oil inlet, the end cap body is connected to an oil box, and the oil box, the first oil inlet, and the oil passage are sequentially connected.

11. A linear motor comprising a stator slide rail and a rotor that slidably fits on the stator slide rail, comprises a ball return end cover of claim 1, and the ball return end cover is connected to the rotor.
